(19) United States
(12) Patent Application Publication
(10) Pub. No.: US 2015/0199626 A1
(43) Pub. Date: Jul. 16, 2015

(54) Incident Recordation and Repair

(71) Applicant: Bank of America Corporation, Charlotte, NC (US)

(72) Inventors: Craig Guthrie, Cornelius, NC (US); Edward J. Walter, JR., Smyrna, DE (US)

(73) Assignee: Bank of America Corporation, Charlotte, NC (US)

(21) Appl. No.: 14/151,915

(22) Filed: Jan. 10, 2014

(51) Int. Cl. G06Q 10/06; G06Q 10/00

(52) U.S. Cl. CPC G06Q 10/0631; G06Q 10/20

(57) ABSTRACT

Systems, methods, and apparatus integrating applications with a common purpose of information technology incident resolution are provided. An indication of an information technology incident is received and may include an incident record associated with the incident. Information may be extracted from the incident record. Various components may be executed to determine a cause of the incident and assist the interacting user with diagnosis and response to the incident. A description of the cause may be identified and a determination may be made as to whether the identified description or keyword statement is available for selection from a list of predefined selections in the incident record. An interacting user can choose to build a keyword statement using the selection lists within the software and then apply the keyword statement to the restoral description of the incident record. Any new descriptions created may be added to the list of predefined descriptions.

### BACKGROUND

Issues with computing devices and other information technology resources can be inconvenient and costly in terms of lost work time, resources required to investigate and/or repair the issue, and the like. However, these information technology issues do occur in all industries, businesses, and entities. Although reducing the occurrence of the incidents would be beneficial, it is not always possible to eliminate every issue or potential issue. Accordingly, it would be beneficial to efficiently and cost effectively address any incidents or issues that occur.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for receiving an indication of an information technology incident. The indication may include an incident record associated with the information technology incident. In some examples, information may be extracted from the incident record and an application may be executed, based on the extracted information, to determine a cause of the information technology incident. In some arrangements, applications or one or more components of applications may be selected for execution to determine a cause of the incident. The one or more applications or components of applications may be selected from a plurality of applications or components configured to determine a cause of an incident.

Additional aspects of the disclosure relate to methods, computer-readable media, and apparatuses for receiving an indication of an information technology incident including an incident record and determining a cause of the incident. In some examples, a description of the cause may be identified and a determination may be made as to whether the identified description is available for selection from a list of predefined selections in the incident record. If not, the description may be added. The system may scan one or more incident records to determine whether any new descriptions have been added. Upon determining that one or more new descriptions have been added, the new descriptions may be added to the list of predefined descriptions.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example information technology incident recordation and repair system according to one or more aspects described herein.

FIG. 4 is an example method of recording an information technology incident and updating a system associated with the incident according to one or more aspects described herein.

FIGS. 5A and 5B illustrate example user interfaces for adding a new description to an incident record according to one or more aspects described herein.

FIGS. 6A and 6B illustrate alternate example user interfaces for adding a new description to an incident record according to one or more aspects described herein.

FIG. 7 illustrates an example method of determining a cause of an information technology incident according to one or more aspects described herein.

FIGS. 8A and 8B illustrate additional example user interfaces that may be used to select or add descriptions according to one or more aspects described herein.

FIGS. 9A-9D illustrate various user interfaces showing one or more applications or components of applications that may be executed to determine a cause of an information technology incident according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

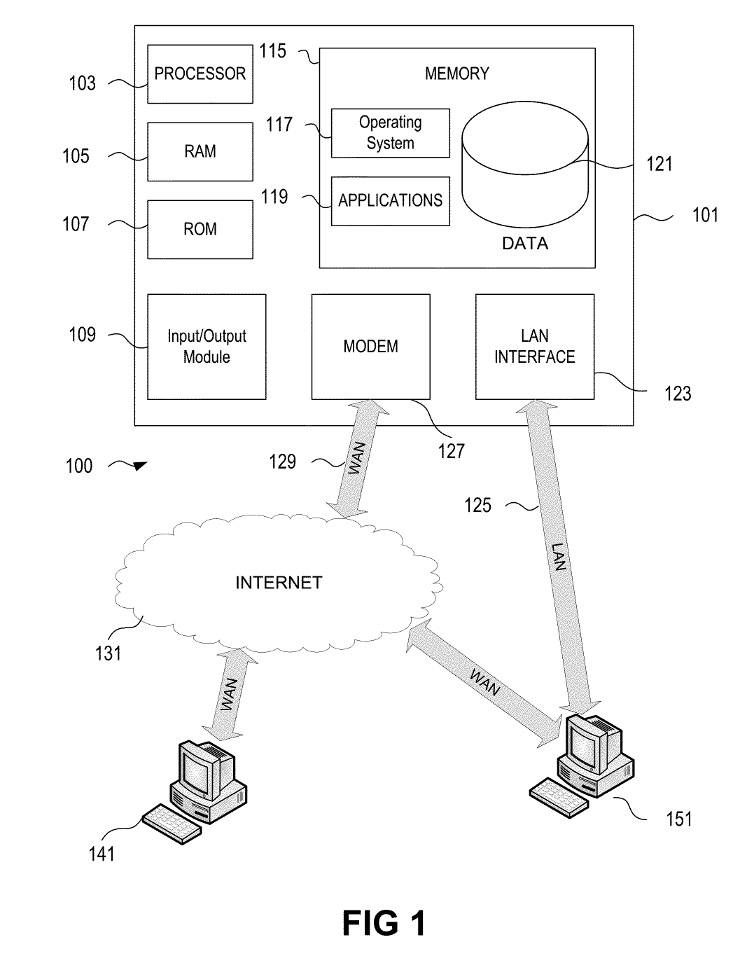

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

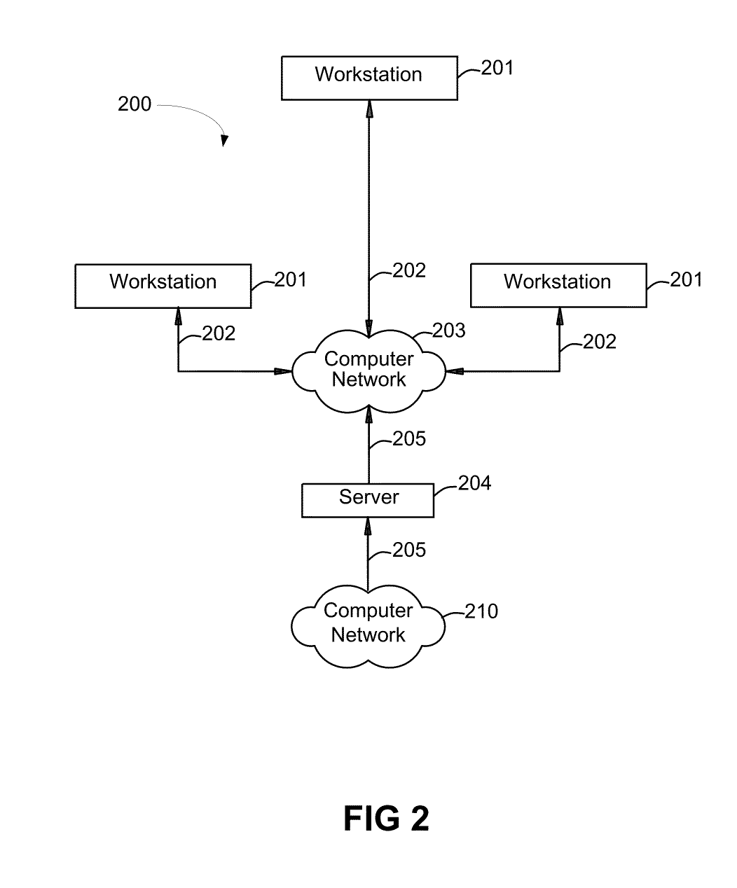

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

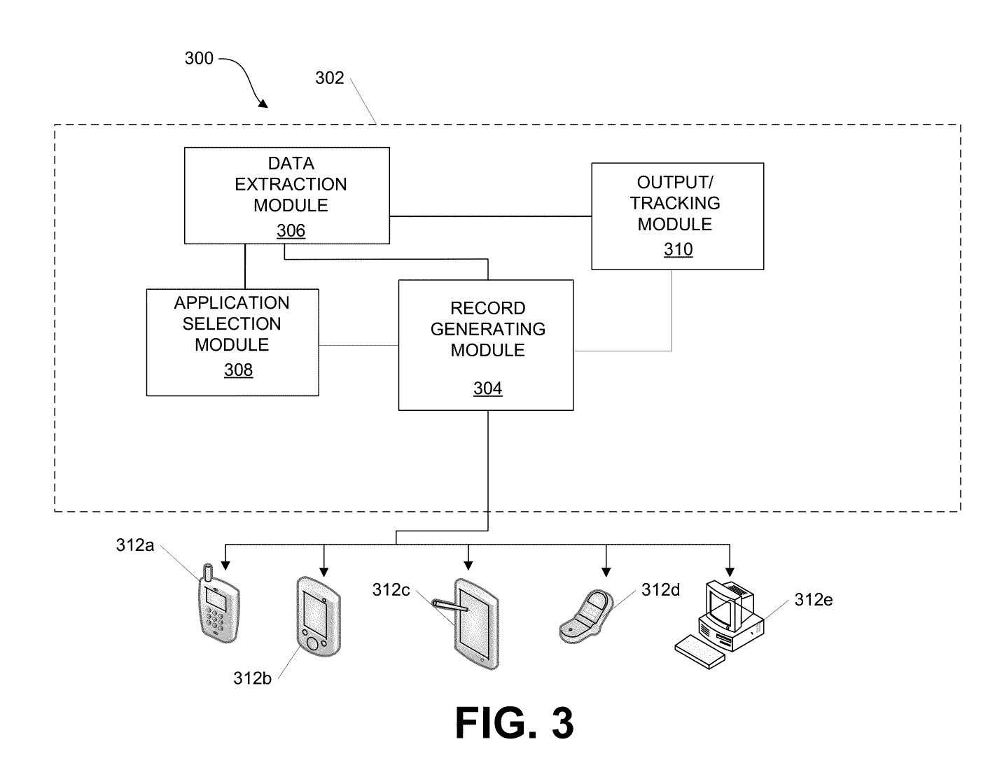

FIG. 3 illustrates one example information technology incident recordation and repair system according to one or more aspects described herein. In some examples, the information technology incident recordation and repair system 300 may be part of, internal to, or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the virtual position display and indication system to use within a financial institution. Rather, the system may be implemented by various other types of entities.

The information technology incident recordation and repair system 300 may include one or more modules that may include hardware and/or software configured to perform various functions within the system 300. For instance, the system 300 may include a record generating module 304. The record generating module 304 may create or receive a record of an information technology incident. For instance, if a device or system, such as a computing device, server, and the like, has a failure or other issue, an incident record may be created in order to record the issue, the device or system associated with the issue, a description of the issue, and any other information associated with the issue. In some arrangements, the incident record may be used to track the issue and facilitate investigation into and/or repair of the issue. For instance, the incident record may track the status of the issue (reported, in process, completed/repaired, and the like). In some examples, the incident may be associated with one or more computing devices, such as computing devices 312a-312e. For instance, the incident may be associated with a smart phone 312a, personal digital assistant 312b, tablet computing device 312c, cell phone 312d, or other computing device 312e. In other examples, a report of the incident, or an incident record, may be received from one or more of computing devices 312a-312e.

Initiation of generation of the incident record may be performed in various ways. For instance, a user may report an issue to an information technology technician who may initiate generation of the incident record. In other examples, a user may report an incident via an email or by inputting information associated with the issue into a user interface associated with a system than will generate an incident record.

The record generating module 304 may generate the incident record or may receive an incident record from another application (e.g., an application associated with another module), device, system, or the like. For instance, the incident recordation and repair system may be integrated with one or more additional systems. In some arrangements, the incident recordation and repair system may be integrated with one or more incident record generation systems such that the systems are connected to or in communication with each other. Accordingly, an incident record generated by an incident record generation system integrated with the incident recordation and repair system described herein may be received by the incident recordation and repair system quickly and efficiently.

In some examples, the incident record may include one or more fields providing information associated with the incident. For instance, one field may include a brief statement of a root cause of an incident. In some arrangements, the field may include a plurality of options available for selection (e.g., from a drop-down or other menu). In some examples, a brief statement may be included in the field that is an option other than one available for selection from the menu (e.g., a “new” statement).

In some arrangements, it may be desirable for this additional or new statement to be included in the menu or list of predefined descriptions or options available for selection. Accordingly, the system and/or record generating module may add, be configured to add or have an option to add the new statement to the list or menu of available statements. In some examples, the system may periodically or aperiodically scan for new statements and may automatically add any new statements to the list of statements available for selection. This arrangement may quickly and efficiently provide updated options for users to select.

The incident recordation and repair system may further include a data extraction module 306. The data extraction module 306 may be connected to or in communication with various other modules within the system 300. For instance, the data extraction module 306 may be connected to or in communication with the record generating module 304. The data extraction module 306 may extract data from an incident record to determine various features of the incident. For instance, the extracted data may aid in determining a type of device associated with the incident, a type of operating system associated with the incident, a type of application associated with the incident, and the like. This information may be used, in some examples, to determine a cause of the incident and/or a repair for the incident.

The incident recordation and repair system 300 may further include an application selection module 308. The application selection module 308 may be connected to or in communication with various other modules within the system 300. For instance, the application selection module 308 may be connected to or in communication with the data extraction module 304. In some examples, the application selection module 308 may identify one or more applications or components of applications to execute in order to identify a cause of the incident based, at least in part, on the data extracted from an incident record (e.g., by the data extraction module 304). For instance, information associated with the type of device associated with the incident, operating system associated with the incident, and the like, may be used to identify one or more applications that may be executed in order to aid in determining a cause of the incident. In some examples, the identified applications may be automatically executed (e.g., by the application selection module 308 or system 300) in order to identify the cause of the incident. Further, in some examples, one or more identified applications may be executed simultaneously or nearly simultaneously in order to efficiently determine a cause of the incident. Accordingly, determining a cause of the incident may be performed quickly and efficiently. In some examples, the identified applications may output information which may be used to determine or confirm a cause of the incident. A technician or other individual may use outputs from the identified applications to determine or confirm the cause of the incident. In some examples, the information may be output to a computing device, such as computing devices 312a-312e, that may be accessed by the technician.

The information technology incident recordation and repair system 300 may further include an output/tracking module 310. The output/tracking module 310 may track progress associated with one or more incidents or incident records. The output/tracking module 310 may track applications identified to determine a cause of the incident (such as by application selection module 308), a determined cause and/or repair associated with the incident, and the like. This information may be stored by the output/tracking module 310 and may be accessed, such as by one or more computing devices (e.g., 312a-312e) to monitor incidents, review historical data associated with one or more incidents, track performance of applications configured to identify a cause of an incident, and the like. In some examples, the output/tracking module 310 may also track similar issues and any corrective actions taken associated with the issues.

One or more modules of the information technology recordation and repair system 300 may be contained in one or more computing devices. For instance, some or all of the modules may be housed within one physical device. Alternatively, some or all of the modules or components of the system 300 may be housed in one or more separate computing devices.

In some examples, the information technology incident recordation and repair system may include a central server. The central server may store information, such as the list of predefined descriptions. Users desiring to access one or more aspects of the incident recordation and repair system may, in some examples, do so via a computing device connected to or in communication with the central server. For instance, a user may download an application from the central server providing some or all of the functionality described herein. Accordingly, when a new description is added, the central server may detect the new description and may add it to the list of predefined descriptions. Further, the central server may transmit, such as to one or more computing devices associated with users accessing the functionality described herein, the updated list of predefined descriptions (e.g., including any newly added descriptions). Thus, the next time a user accesses the system, the list of predefined descriptions may be updated to include the newly added descriptions. In some examples, this process may be performed automatically (e.g., without any additional input from a user, administrator, or the like).

These and various other aspects will be discussed more fully below.

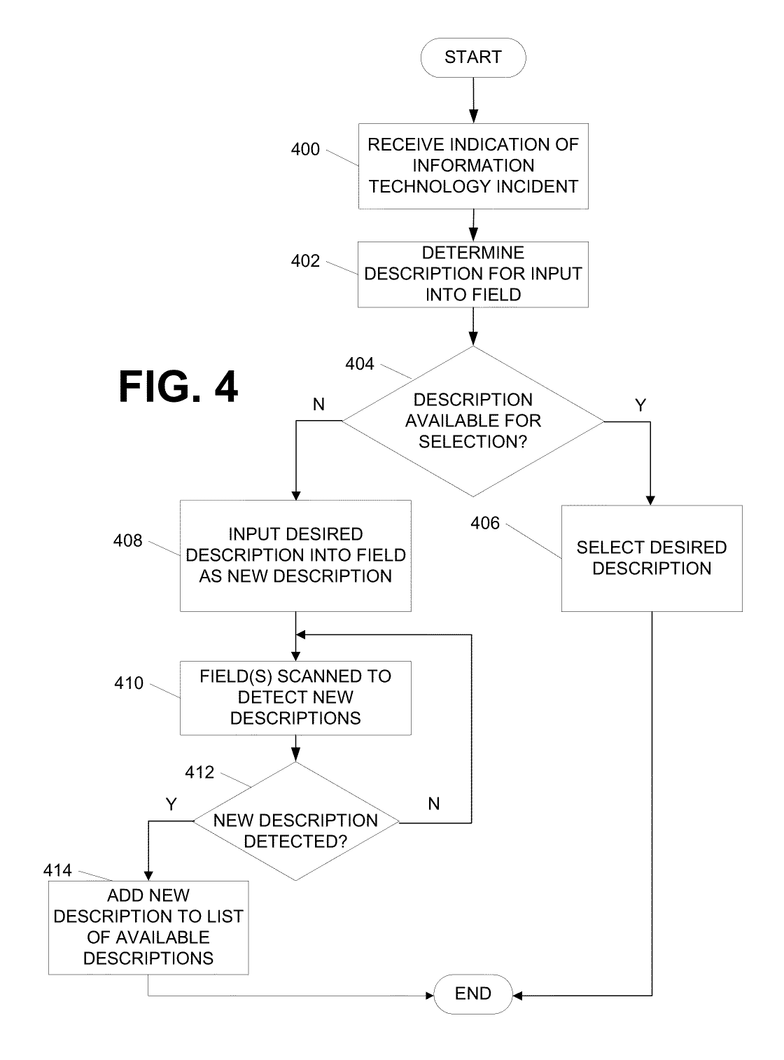

FIG. 4 illustrates one method of recording an information technology incident and updating a system associated with the recordation of the information technology incident. In step 400, an indication of an information technology incident is received. In some examples, the indication may include an incident record (e.g., an incident record generated by another system, application, or the like and transmitted to the system). In other examples, the indication may be only an identification of the incident and an incident record may be generated (e.g., by record generating module 304).

Various information may be input into one or more fields in the incident record. For instance, upon determining a cause of the incident (e.g., after investigation, processing, and the like), a brief description of the cause of the incident may be input into a field in the incident record. In step 402, an appropriate description may be determined for input into a field (such as a field for inputting a cause of the incident). In step 404, a determination may be made as to whether the desired description is available for selection from a list of predefined descriptions (e.g., from a menu, drop-down menu, and the like). If, in step 404, the desired description is available, the desired description may be selected in step 406.

If, in step 404, the desired description is not available, the desired description may be input in the field as a new description (e.g., a description not available from the list of predefined options). In some examples, input of the new description may include selection of an option such as “other” which may then prompt the user to input the new description in another interface, field, or the like. In other examples, a user may input the new description directly into the field provided.

In step 410, the system may scan one or more fields of one or more incident records to determine whether any new or additional descriptions have been added. In some examples, the scan may be performed on a periodic or aperiodic basis. For instance, a scan may be done each day, each week, multiple times throughout a day, and the like. In step 412, a determination is made as to whether any new descriptions have been detected. If, in step 412, no new descriptions have been added, the process may return to step 410 to scan the system. Alternatively, if a new description is detected, the new description may be added to the list of predefined descriptions in step 414. In some arrangements, the new description may be automatically added. In other examples, addition of the new description may require approval, such as from a system administrator. Accordingly, the scanning for new descriptions and addition to the list of predefined descriptions may quickly and efficiently provide the most updated options available for users.

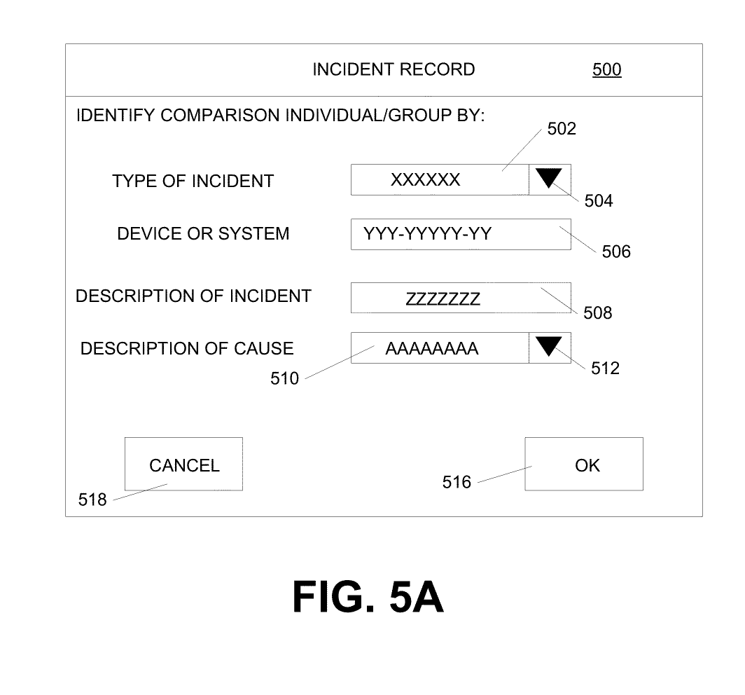

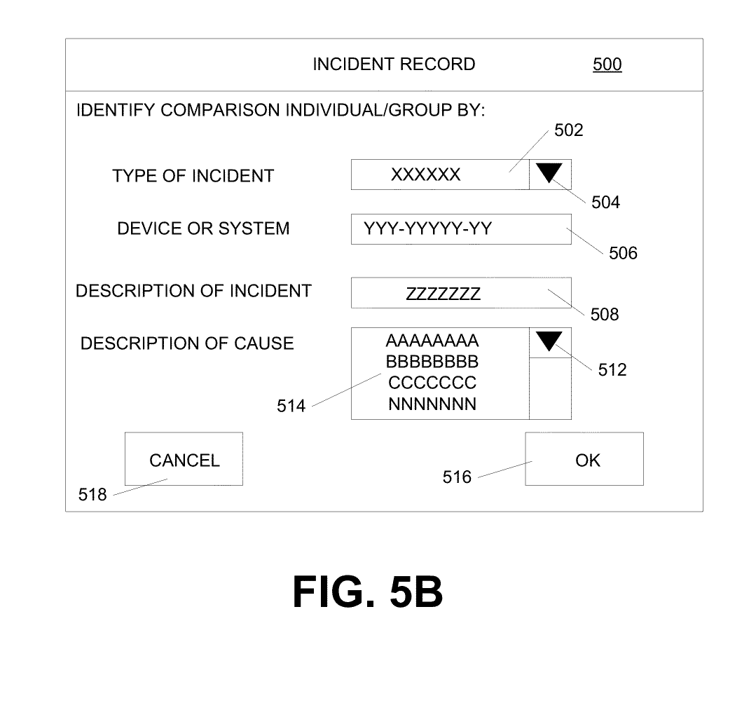

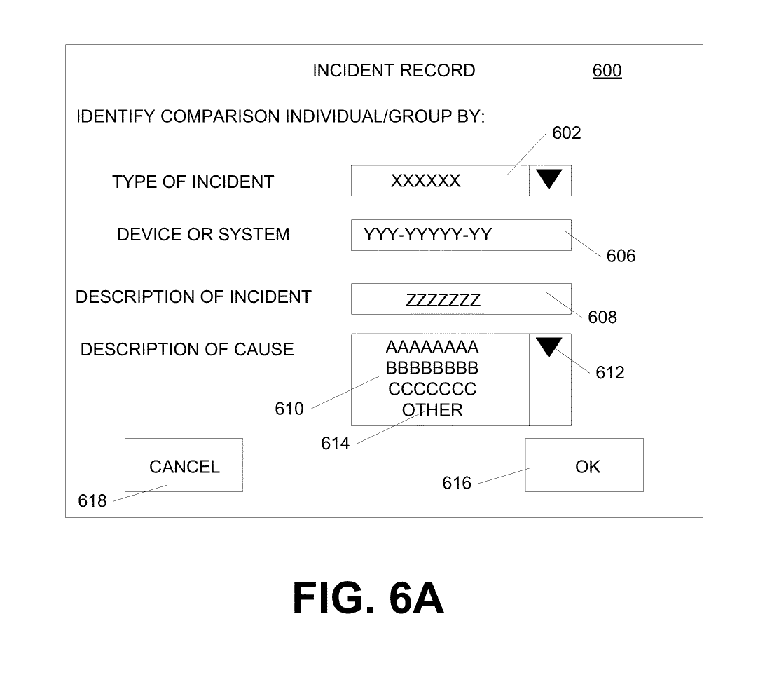

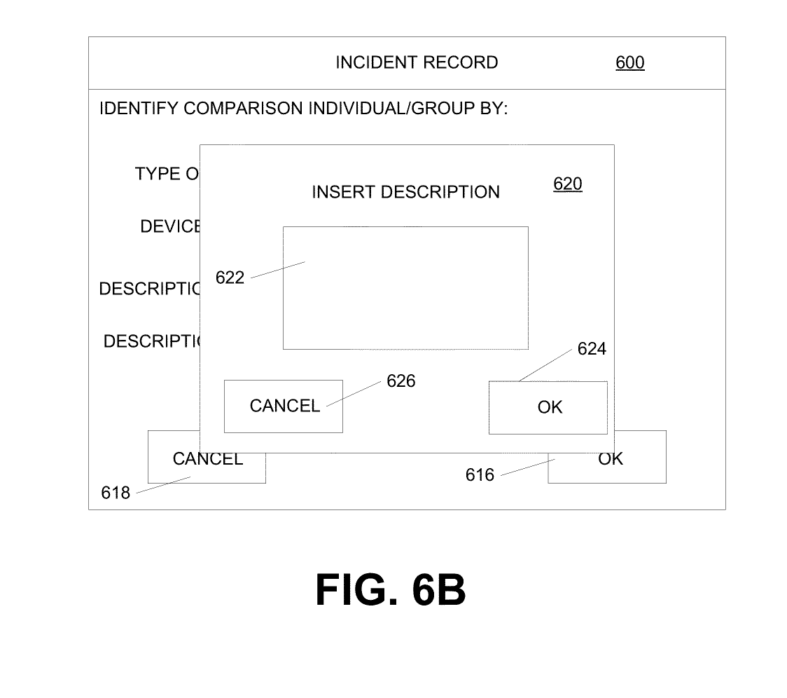

FIGS. 5A-6B illustrate various user interfaces that may be used to add a new description, according to some arrangements described herein. The arrangements shown are some examples of how the description may be added and should not be viewed as limiting the process to only those arrangements shown. Rather, various other methods of adding a new description may be used without departing from the invention.

FIG. 5A illustrates one example user interface 600 illustrating an example incident record. Additional or other information may be provided in an incident record without departing from the invention. In field 502, a type of incident may be identified. In some examples, the type of incident may be input, such as by a user, by clicking or double-clicking in field 502. In other examples, the type of incident may be selected from a drop-down menu available by clicking arrow 504. Field 506 includes an identification of the device or system associated with the incident. Field 508 includes a description of the incident.

Field 510 includes a description of the cause of the incident. For instance, once the investigation into the incident is complete and a cause is determined, the cause may be input into the incident record in order to complete, close out, or the like, the record. In some examples, the cause input may also be used to track incidents, historical information associated with a device, system, application, and the like. A user may input a description (e.g., a description not included in a list of predefined options) by typing it into field 510 (e.g., after clicking or double-clicking in field 510). In arrangements in which the desired description is input into field 510, a user may then select “OK” option 516 to process the incident record and save the selections, or may select “CANCEL” option to clear or reset the information fields.

Field 510 also may include an arrow 512 that may be used to expand a menu of options available for selection. For instance, a user may type a desired description into field 510 (either a new description or description in the list of predefined descriptions) or the user may select an option from the list of predefined options provided by selecting arrow 512. FIG. 5B illustrates the user interface 500 with drop down menu 514 expanded. A user may select an option from one or more of the predefined descriptions available. More or fewer options may be provided without departing from the invention. In arrangements in which the number of options exceeds the window of the drop-down menu, a scroll bar may be provided to view additional selections.

Once the desired selections have been made a user may select “OK” option 516 to process the incident record and save the selections, or may select “CANCEL” option to clear or reset the information fields. When the system scans the incident records to determine whether any new descriptions have been provided, as discussed above, any new description added (e.g., in field 510) will be detected and may be added to the list of predefined descriptions so that it may be used again on future incident records.

FIG. 6A illustrates another example user interface 600. Similar to the interface 500 in FIGS. 5A and 5B, the interface 600 includes field 602 to identify a type of incident, field 606 for identifying a device or system, and field 608 providing a description of the incident. Interface 600 may further include field 610 in which a description of the incident may be input. As shown in FIG. 6A, field 610 is expanded (e.g., by selecting arrow 612) and includes a plurality of options available for selection. A user may select a description from the list of predefined descriptions or may select “other” option 614. Selection of “other” option 614 may prompt an additional user interface, such as interface 620 shown in FIG. 6B.

Interface 620 includes field 622 in which a “new” or additional description (e.g., a description not included in the list of predefined descriptions) may be provided, such as by a user. The user may input the new description into field 622 and may select “OK” option 624 to add the new description to field 610 in user interface 600. Alternatively the user may select “CANCEL” option 626 which may return the user to the previous user interface (e.g., interface 600).

Once the new description is inserted into the incident record, the user may select “OK” option 616 in interface 600 to process the information provided. Accordingly, when the system scans the incident records to determine whether any new descriptions have been provided, as discussed above, the new description will be detected and will be added to the list of predefined descriptions so that it may be used again on future incident records.

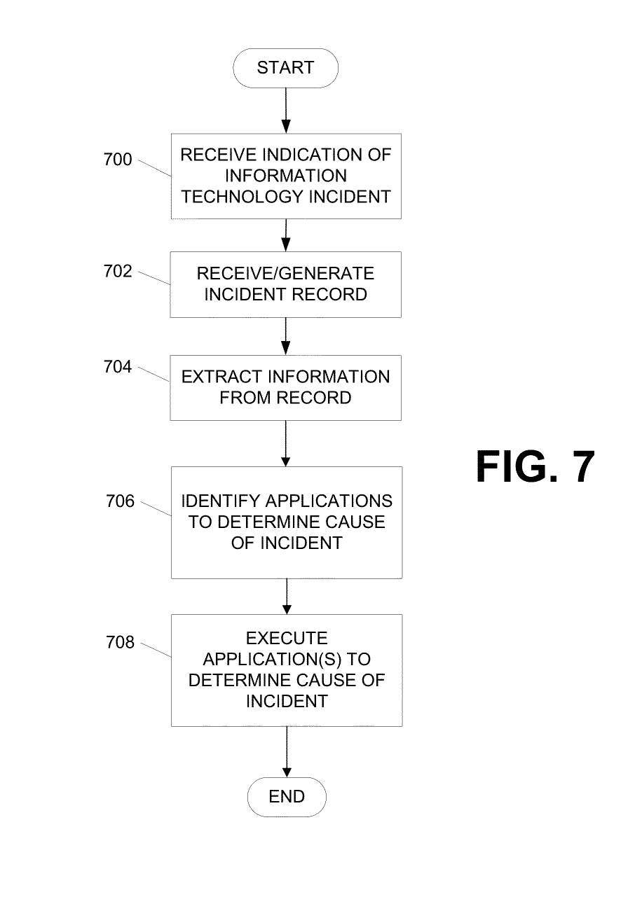

FIG. 7 illustrates one example method of determining a cause of an information technology incident according to one or more aspects described herein. In step 700, an indication of an information technology incident may be received. In step 702, an incident record associated with the information technology incident may be generated (e.g., based on the indication of the incident) or may be received (e.g., from another system, application, or the like).

Similar to the arrangements discussed above, the incident record may include information associated with the information technology incident. For example, the incident record may include identification of one or more pieces or hardware (e.g., computing devices) associated with the incident, one or more operating systems associated with the incident, one or more applications associated with the incident, and the like. The incident record may also include information associated with a duration of the incident, a description of the incident, and the like. In step 704, data may be extracted from the incident record. As discussed above, the extracted information may be related to the hardware and/or software associated with the information technology incident.

In step 706, one or more applications may be identified that may aid in determining a cause of the incident. The one or more applications may be identified based, at least in part, on the information extracted from the incident record. The one or more applications may include applications configured to diagnose or determine a cause of the incident. For instance, the applications may run various tests, such as diagnostic tests, to determine whether the device, system, application, or the like is operating normally and, if not, to isolate or identify the issue and/or the cause of the issue.

In step 708, the identified one or more applications may be executed to determine or aid in determining a cause of the incident. In some examples, the one or more identified applications may be executed automatically by the system. Additionally or alternatively, the one or more identified applications may be executed simultaneously or nearly simultaneously in order to efficiently determine the cause of the incident.

As discussed above, in some examples, an output from the one or more identified applications may be used, such as by a technician, to determine or confirm a cause of the incident. The output information may be used to determine a cause and, in some examples, to identify one or more corrective measures which may be taken.

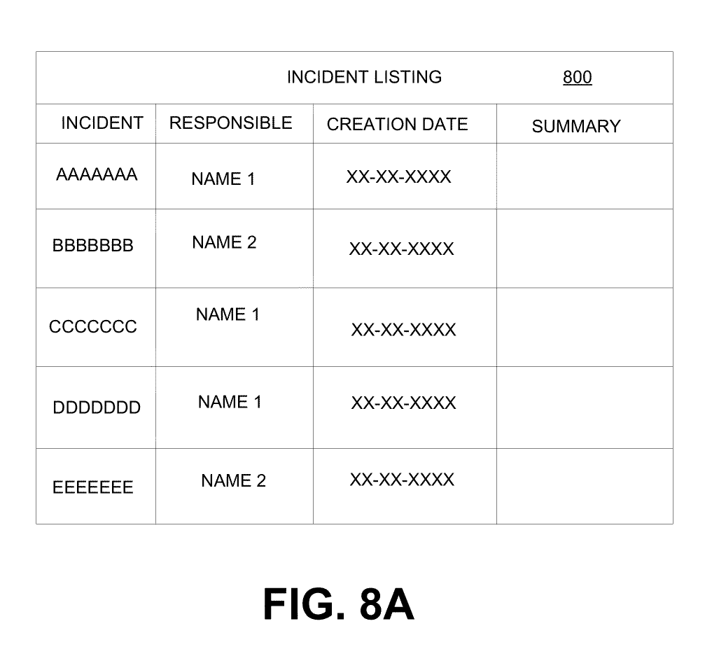

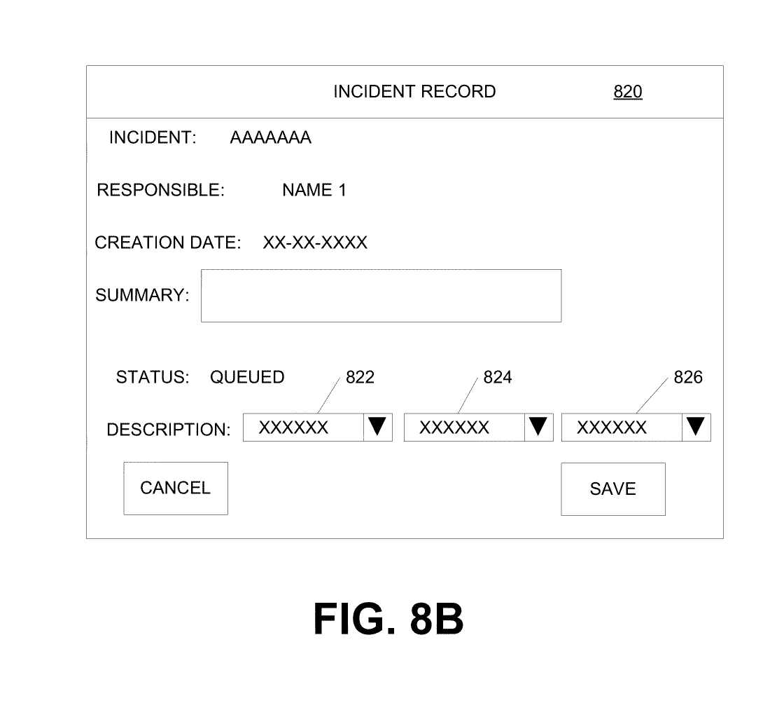

FIGS. 8A and 8B illustrate user interfaces that may be used to add or select a description according to one or more aspects described herein. Interface 800 in FIG. 8A provides a listing of a plurality of information technology incidents. The interface includes an incident identifier, such as a number, name, or the like, as well as a name of a responsible person. The interface 800 further includes a date of creation of the incident record (e.g., the date the information technology incident was identified, reported, or the like) and a summary of the incident.

FIG. 8B illustrates a user interface 820 that may be provided upon selection of an incident from the incident listing provided in interface 800 in FIG. 8A. For instance, if a user selects incident “AAAAAA” from interface 800, interface 820 may be provided which includes an incident record for incident “AAAAAA.” The individual responsible for handling the incident may also be provided in interface 820. Further, a summary of the information technology incident may be provided, as well as a status of the incident.

Interface 820 may further include one or more fields or drop-down menus from which a user (e.g., a technician responsible for handling the incident) may select a description or string of terms related to the incident. For instance, a user may select a keyword from each of drop-down menus 822, 824 and/or 826. Accordingly, the user may build a string of terms providing information about the incident, its restoral information, and the like. In some examples, the selected string may be used to identify one or more applications or components of applications to execute in order to determine a cause of the incident and/or an appropriate repair.

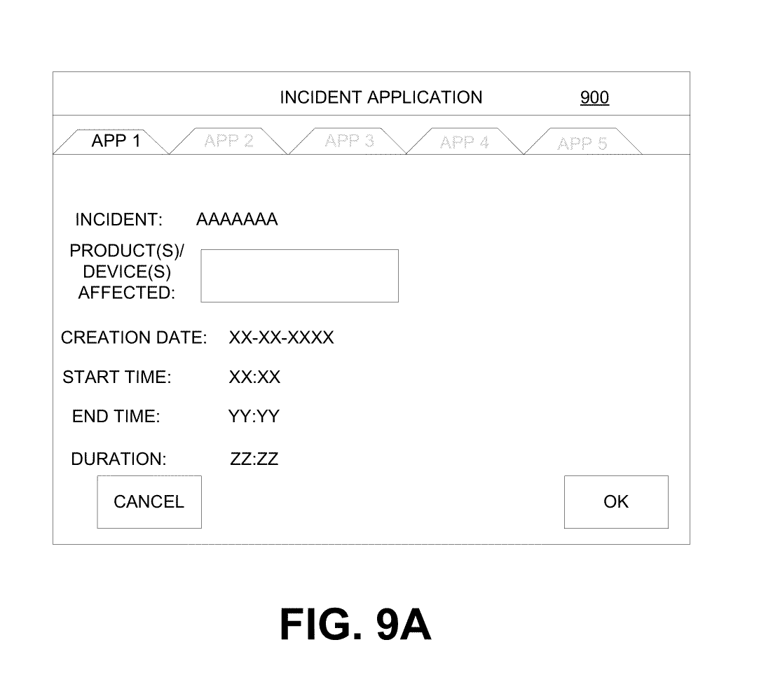

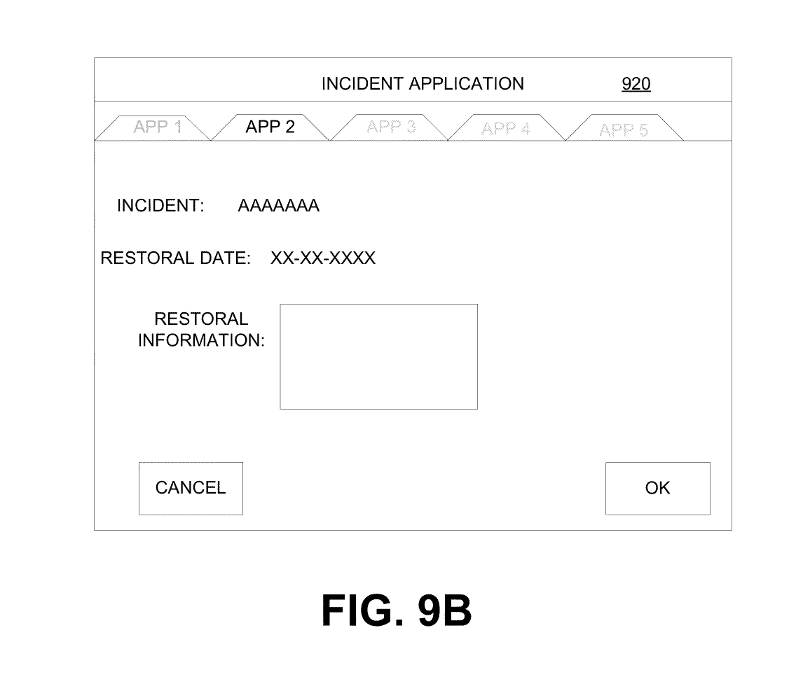

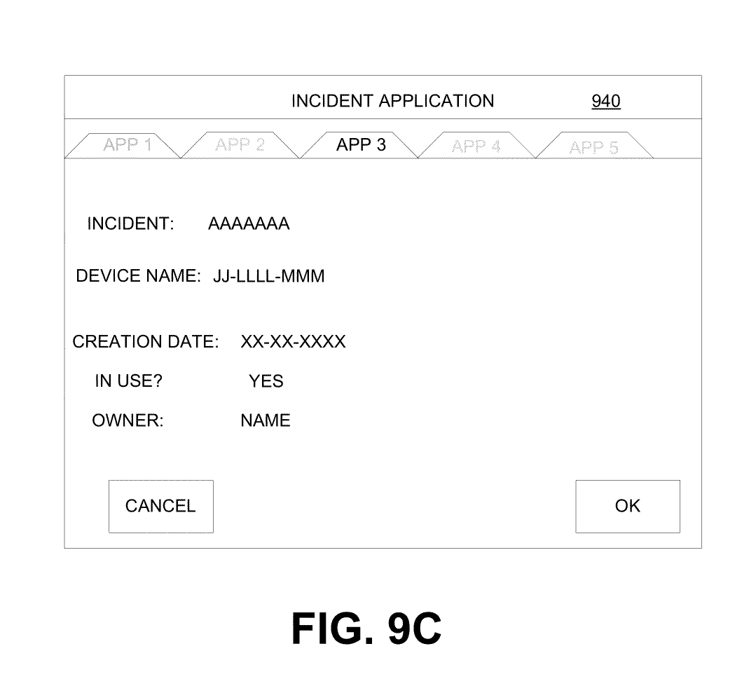

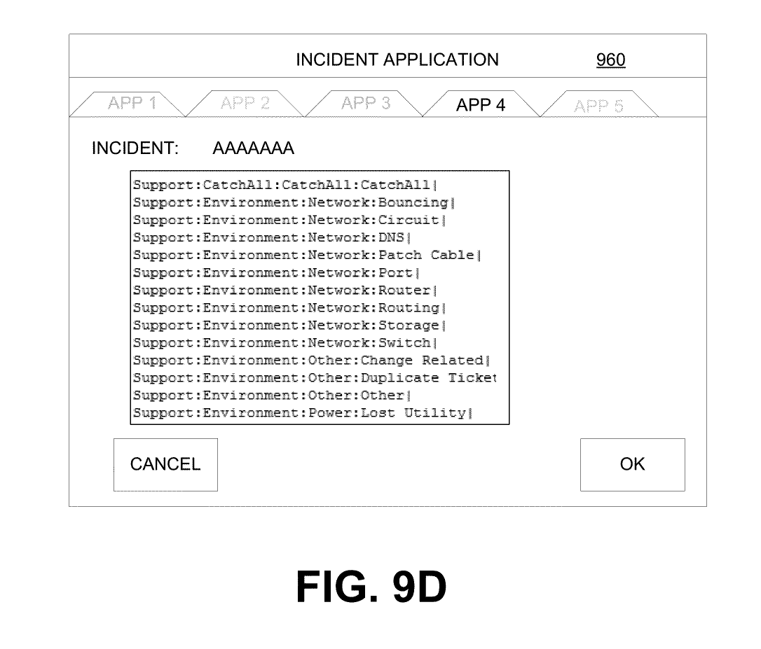

FIGS. 9A-9D illustrate some example user interfaces associated with various applications or application components that may be executed to determine a cause of an information technology incident. For instance, FIG. 9A includes user interface 900 which illustrates details associated with “App 1” or application 1. Application 1 may be an application or component of an application that may be selected and/or executed in order to aid a technician or other user in determining a cause of an information technology incident. For instance, as discussed above, one or more applications may be selected from a plurality of applications available to aid in determining a cause of an incident and/or any appropriate repair. Interface 900 includes a plurality of tabs associated with the different applications (labeled “App 1,” “App 2,” “App 3,” “App 4,” and “App 5” in this example). In interface 900, details associated with App 1 are provided and the other tabs are shown grayed out to indicate that they are not actively viewed.

In the example interface 900, App 1 may relate to production log information and may include information such as the incident identifier, products or devices affected by the incident, the date on which the incident record was created, the start and end time for addressing the incident and/or a duration of time to repair the incident. Additional information may also be provided.

FIG. 9B illustrates another example user interface 920 associated with another application (e.g., App 2). This application may provide restoral information to the technician.

FIG. 9C illustrates yet another example user interface 940 that may provide information related to the device or devices affected by the incident. FIG. 9D illustrates another user interface 960 that may provide information related to string data. The information from each of these interfaces (e.g., generated by executing the applications to determine a cause and/or repair of an incident) may be used to assist a technician in quickly and efficiently determining a cause of an incident.

Further, as discussed above, the information generated by the applications may be stored and tracked to provide historical information that may be used in handling future information technology incidents. The historical information may also be used to track performance (e.g., of one or more systems, technicians, and the like). The data may be presented in a variety of ways, such as tables, graphs, and the like.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive an incident record associated with an information technology incident;
determine a cause of the information technology incident;
identify a description of the cause of the information technology incident to be input into the incident record;
determine whether the identified description is available for selection from a list of predefined descriptions;
responsive to determining that the identified description is not available for selection from a list of predefined descriptions, inputting the identified description into the incident record;
scanning the incident record to detect any descriptions input into the incident record that are in the list of predefined descriptions; and
responsive to detecting the identified description as a description input into the incident record that is not in the list of predefined descriptions, adding the identified description to the list of predefined descriptions.

2. The apparatus of claim 1, wherein scanning the incident record includes scanning a plurality of incident records to detect any descriptions input into any incident record of the plurality of incident records that is not in the list of predefined descriptions.

3. The apparatus of claim 1, further including instructions that, when executed, cause the apparatus to transmit the list of predefined descriptions including the added identified description to a plurality of computing devices.

4. The apparatus of claim 1, wherein the scanning the incident record is performed automatically on a periodic or aperiodic basis.

5. The apparatus of claim 1, wherein the adding the identified description to the list of predefined descriptions is performed automatically.

6. The apparatus of claim 1, further including instructions that, when executed, cause the apparatus to:
responsive to not detecting any descriptions that are not in the list of predefined descriptions, scanning another incident record to detect any descriptions that are not in the list of predefined descriptions.

7. An apparatus, comprising:
at least one processor; and
a memory storing computer-readable instructions that, when executed by the at least one processor, cause the apparatus to:
receive an indication of an information technology incident, the indication of the information technology incident including an incident record of the information technology incident;
extract information from the incident record, the extracted information being associated with the information technology incident; and
automatically execute, based on the extracted information, components that have been configured to determine a cause of the incident.

8. The apparatus of claim 7, further including instructions that, when executed, cause the apparatus to:
automatically execute, based on the extracted information, additional application components that have been configured to determine the cause of the incident.

9. The apparatus of claim 8, further including instructions that, when executed, cause the apparatus to:
select, based on the extracted information, the first application configured to determine a cause of the incident and the second application configured to determine the cause of the incident, from a plurality of applications configured to determine a cause of an incident.

10. The apparatus of claim 8, wherein the first application and the second application are executed simultaneously to determine the cause of the incident.

11. The apparatus of claim 7, wherein receiving the indication of the information technology incident includes generating the incident record.

12. The apparatus of claim 7, wherein receiving the indication of the information technology incident includes receiving the incident record from an incident record generation system integrated with the apparatus.

13. The apparatus of claim 7, wherein the extracted information includes at least one of: a type of device associated with the information technology incident and a type of application associated with the information technology incident.

14. One or more non-transitory computer-readable media having computer-executable instructions stored thereon that, when executed, cause at least one computing device to:
receive an indication of an information technology incident, the indication of the information technology incident including an incident record of the information technology incident;
extract information from the incident record, the extracted information being associated with the information technology incident; and
automatically execute, based on the extracted information, additional application components that have been configured to determine a cause of the incident.

15. The one or more non-transitory computer-readable media of claim 14, further including instructions that, when executed, cause the computing device to:
automatically execute, based on the extracted information, additional application components that have been configured to determine the cause of the incident.

16. The one or more non-transitory computer-readable media of claim 15, further including instructions that, when executed, cause the computing device to:
select, based on the extracted information, additional application components that have been configured to determine a cause of the incident and additional application components that have been configured to determine the cause of the incident, from a plurality of application components that have been configured to determine a cause of an incident.

17. The one or more non-transitory computer-readable media of claim 15, wherein the first application and the second application are executed simultaneously to determine the cause of the incident.

18. The one or more non-transitory computer-readable media of claim 14, wherein receiving the indication of the information technology incident includes generating the incident record.

19. The one or more non-transitory computer-readable media of claim 14, wherein receiving the indication of the information technology incident includes receiving the incident record from an incident record generation system integrated with the apparatus.

20. The one or more non-transitory computer-readable media of claim 14, wherein the extracted information includes at least one of: a type of device associated with the information technology incident and a type of application associated with the information technology incident.
